(19) United States
(12) Patent Application Publication
(10) Pub. No.: US 2011/0219826 A1
(43) Pub. Date: Sep. 15, 2011

(54) SECURITY STRAP

(75) Inventors: RICHARD JELI, MILWAUKIE, OR (US); KEVIN E. LESLEY, BEAVERTON, OR (US)

(73) Assignee: Yakima Products, Inc., Beaverton, OR (US)

(21) Appl. No.: 12/877,928

(22) Filed: Sep. 8, 2010

Related U.S. Application Data
(60) Provisional application No. 61/240,594, filed on Sep. 8, 2009.

(51) Int. Cl. E05B 71/00; E05B 73/00

(52) U.S. Cl. 70/15

(57) ABSTRACT

A security device for securing an object to a vehicle is provided including a loop member having a fixed interior circumference and an anchor member having a circumference that is less than the fixed interior circumference. The security device may further include a flexible cut-resistant strap member extending at least between the loop member and the anchor member, the strap member including cut-resistant material, wherein the length of the strap member between the loop member and the anchor member is at least long enough to allow threading of the anchor member through the loop member. Some embodiments of the security device may include a strap member having a substantially flat portion and/or maximum thickness adjacent the anchor member, such that the strap member may be closed within a vehicle barrier and vehicle frame, for example, a car door, and the anchor member may be trapped within the vehicle.

### CROSS-REFERENCE TO RELATED APPLICATIONS

This application claims priority to U.S. Provisional Patent Application Ser. No. 61/240,594 filed Sep. 8, 2009, which is incorporated herein by reference in its entirety for all purposes.

### BACKGROUND

Security is a constant concern these days. In and around vehicles people are constantly carrying valuable cargo which may be stolen when unattended, such as bicycles, or other cargo, on roof-mounted vehicle racks. To address this security concern, some bicycle racks include a tray for receiving one or more bicycles tires and a locking mechanism for locking the bicycle into place. These locking mechanisms include such things as fork mounts (which require the removal of the front tire, and lock the individual tines of the fork into place), and other types of locking devices which lock onto various parts of a bicycle.

One problem associated with fork-mount-type locking mechanisms is that the front tire of the bicycle must be removed every time one desires to transport a bicycle to a different location, which may be time consuming, cumbersome and may negatively affect the fine tuning of the bicycle. Some proposed solutions to the above problem include locking mechanisms or devices which lock onto other parts of a bicycle or any other carried object. While a number of such devices are known, the known devices are limited in utility because, among other reasons, they either: (1) require the precise placement of an object in a rack; (2) are not readily lockable for protecting against theft; (3) do not easily accommodate different-sized objects; and/or (4) are bulky or cumbersome to use.

Improved security devices are needed for securing objects to or around a vehicle.

### SUMMARY

A security device for securing an object to a vehicle is provided including a loop member having a fixed interior circumference and an anchor member having a circumference that is less than the fixed interior circumference. The security device may further include a flexible cut-resistant strap member extending at least between the loop member and the anchor member, the strap member including cut-resistant material, wherein the length of the strap member between the loop member and the anchor member is at least long enough to allow threading of the anchor member through the loop member. Some embodiments of the security device may include a strap member having a substantially flat portion and/or maximum thickness adjacent the anchor member, such that the strap member can be closed within a vehicle barrier (car door or trunk) and the vehicle frame trapping the anchor member within the vehicle.

A method of securing an object to a vehicle having a barrier and a barrier frame is also provided. A security device includes an anchor member and a cut-resistant strap member. The strap member has a loop portion. The anchor member is wrapped around a portion of the object to be secured. The anchor member is then threaded through the loop portion encircling the object. The anchor member is then captured within the vehicle such that the loop portion is outside the vehicle and the anchor member is inside the vehicle, thereby securing the object to the vehicle.

The advantages of the present disclosure will be more readily understood after considering the drawings and the Detailed Description.

### BRIEF DESCRIPTION OF THE DRAWINGS

FIG. 1 is a top view of a security device for securing an object to a vehicle in accordance with the present disclosure, showing a strap member, an anchor member and a loop member.

FIG. 2 is a side view of the security device of FIG. 1.

FIG. 3 is a partial perspective view of the security device of FIG. 1, showing the anchor member secured inside a vehicle adjacent a door, and the strap member and the loop member secured to a bike frame.

FIGS. 4A-4D are partial views of the security device of FIG. 1, showing various embodiments of a cut-resistant material that may be included in the strap member and/or the loop member.

FIG. 5 is a flow chart of an exemplary method of securing an object to a vehicle having a barrier and a barrier frame in accordance with the present disclosure.

FIG. 6 is a partial cut-away perspective view of a cut-resistant strap configuration.

### DETAILED DESCRIPTION

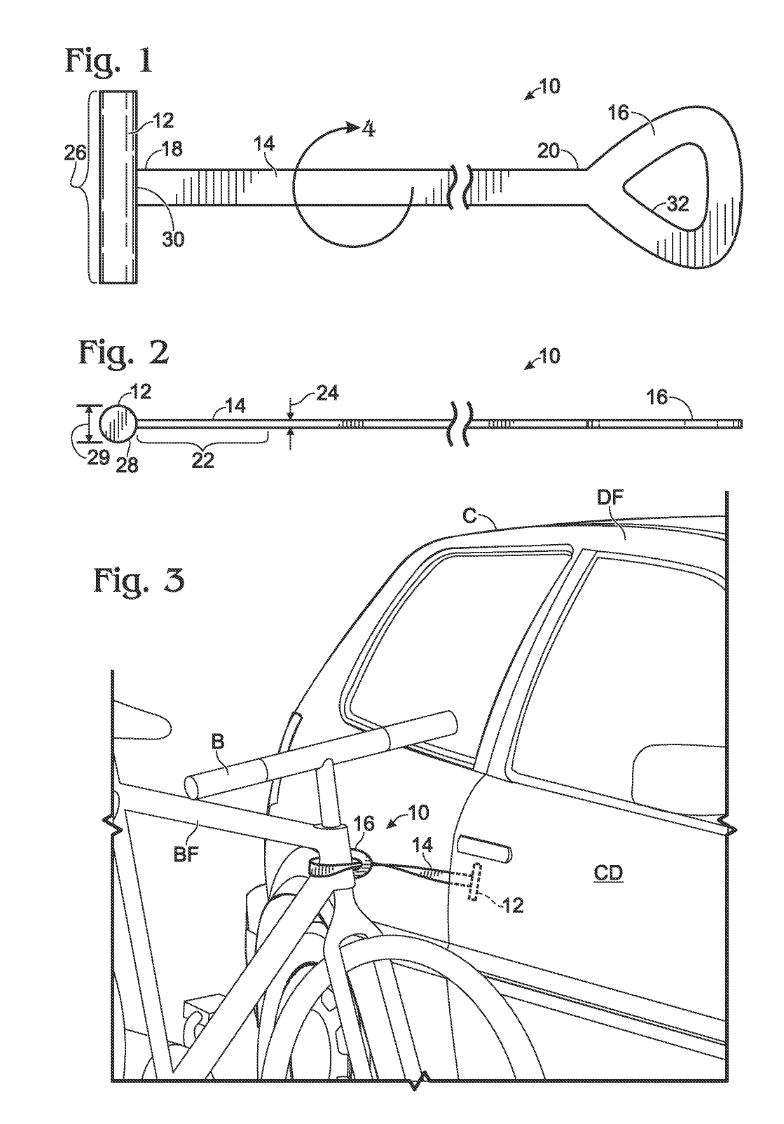

As shown in FIGS. 1-3, a security device for securing an object to a vehicle in accordance with the present disclosure, generally indicated at 10, may include an anchor member 12, a strap member 14, and a loop member 16. In some embodiments, anchor member 12 may be at a first end 18 of strap member 14 and loop member 16 may be at a second end 20 of strap member 14. The disclosed security device 10 may be used in conjunction with any object to be secured having a closed loop or aperture in its structure, such as a bicycle B having a bike frame BF (FIG. 3). Additionally and/or alternatively, the object to be secured may include any object having a closed loop or aperture firmly fastened to its structure, such that the security device may pass through the aperture. Non-limiting examples of securable objects in accordance with the present disclosure include bicycles, cargo containers, kayaks, skis, snowboards, etc.

The vehicle, in accordance with the present disclosure, may include any movable or immovable object having a swinging or sliding barrier that will close within a barrier frame to block entrance to the object. Non-limiting examples of a vehicle include a car C having a car door CD and a car door frame DF (FIG. 3), a trunk and/or a window, or a building having a door, a door frame and/or a window. Additionally and/or alternatively, the vehicle may include any object having means to trap the security device between the vehicle and an immovable structure, such as the ground, for example by rolling onto a portion of the security device, to secure the object between the vehicle and the immovable structure. The vehicle may include additional security means that may prevent the vehicle from being taken away and/or broken into, such as a lock system, an alarm, and/or the vehicle's own weight.

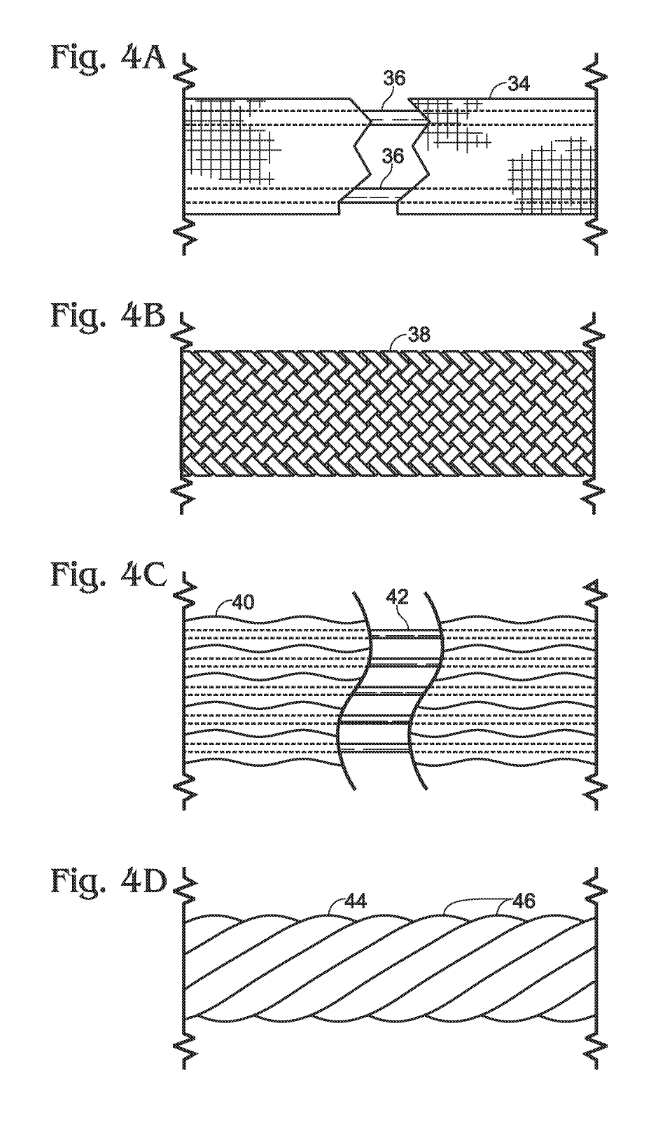

Strap member 14 may extend at least between anchor member 12 and loop member 16 and may include cut-resistant material, as discussed in further detail below with reference to FIGS. 4A-4D, and may be substantially flexible such that anchor member 12 may be threaded through loop member 16. Additionally and/or alternatively, the length of strap member 14 between loop member 16 and anchor member 12 may be at least long enough to allow threading of anchor member 12 through loop member 16. As best shown in FIG. 2, at least a portion of strap member 22 adjacent anchor member 12 may be substantially flat and/or include a maximum thickness 24, or a thickness limit, for at least the portion of strap member 22 adjacent anchor member 12. For example, maximum thickness 24 may be such that car door CD may close on a portion of strap member 22 adjacent anchor member 12 without interference with closing operation of the door closure or door lock mechanism (FIG. 3). In some embodiments, maximum thickness 24 may be approximately, for example, 0.25 inches (6.35 millimeters). Strap member 14 may include a uniform thickness or a variable thickness across the length of strap member 14.

Anchor member 12, also referred to as the enlarged portion, may include a handle, or rod-like portion, having a length 26 and/or a circumference 28 and strap member 14 may extend from the center portion 30 of anchor member 12. Length 26, circumference 28, and/or diameter 29 of anchor member 12 may be greater than maximum thickness 24 of strap member 14 such that anchor member 12 may be retained within vehicle C when vehicle barrier CD is closed within vehicle frame CF (FIG. 3). All or a portion of length 26 and/or a circumference 28 of anchor member 12 may be substantially resistant to bending and/or substantially rigid such that anchor member 12 may not compress, slip or be pulled through when vehicle barrier CD is closed within vehicle frame CF (FIG. 3).

Other embodiments of the security device may include an anchor member having an alternative configuration, for example a sphere, or other appropriate geometric shape, provided that anchor member 12 is configured to be threaded through loop member 16. Loop member 16 may include a fixed interior circumference 32. At least one of anchor member 12, length 26 and/or a circumference 28 may be less than fixed interior circumference 32 such that anchor member 12 may be threaded through loop member 16. Loop member 16 may include a cut-resistant material, as described in further detail with reference to FIGS. 4A-4D.

As shown in FIG. 3, the object to be secured, such as bicycle B, may be adjacent the vehicle, such as car C. Anchor member 12 may be threadable through loop member 16 such that security device 10 may encircle a portion of the object to be secured, such as bike frame BF. Substantially, flat portion 22 of strap member 14 may be sandwiched between vehicle barrier CD and vehicle frame CF such that anchor member 12 may be trapped within car C. The vehicle barrier CD and the vehicle frame CF may be lockable for additional security. One or all of anchor member 12, strap member 14 and/or loop member 16 may be coated in a protective material such that the object to be secured and/or the vehicle is not scratched or otherwise damaged by security device 10. Additionally and/or alternatively, one or all of anchor member 12, strap member 14 and/or loop member 16 may include a mold resistant material.

Turning now to FIG. 4A-4D, strap member 14 and/or loop member 16 may be constructed of materials for the purpose of resisting cutting and/or flexibility, such as a textile, nylon, polypropylene or polyester material reinforced with a second material to add greater tensile strength. The textile material and/or the reinforcing material may prevent cutting of strap member 14 and/or loop member 16 material by a knife or other cutting implement to improve theft resistance. The cut resistance of strap member 14 and/or loop member 16 may be cut resistant to the use of knives, scissors, sheet metal shears or other common hand tools. Strap member 14 and/or loop member 16 may not be cut resistant to use of a combination of tools, such as knife to cut through the webbing first then a bolt cutter or other special tool to cut through the wire rope, or the use of power tools.

Strap member 14 and/or loop member 16 may have a substantially flat cross-section. Alternatively, strap member 14 and/or loop member 16 may include one or more segments of chain, wire, cable, cord, or any other type of cut-resistant substantially flexible material. Strap member 14 and/or loop member 16 may have mainly a circular, or other non-flat, cross-section, as long as there is at least a small segment of thin material near anchor member 12, allowing strap member 14 to pass through a relatively small gap in the body of the vehicle.

For example, nylon, polypropylene or polyester webbing with inserted wired rope (single rope or multiple ropes, braided-wire ropes) may be used for strap member 14 and/or loop member 16. Alternatively, nylon, polypropylene or polyester webbing with inserted flat woven steel webbing, or coated wire ropes may also be used. Over-molded steel cords or belts, like a steel-corded tires or timing belts (single cord or multiple cords) may also be used.

The cut-resistant materials shown in FIGS. 4A-4D are non-limiting examples of cut-resistant materials that may be included in strap member 14 and/or loop member 16 in accordance with the present disclosure. As shown in FIG. 4A, strap member 14 and/or loop member 16 may include a textile, nylon, polypropylene or polyester material 34 and a plurality of metal strands 36 running through material 34. Additionally and/or alternatively, strap member 14 and/or loop member 16 may include braided wire ropes 38 (FIG. 4B). Additionally and/or alternatively, strap member 14 and/or loop member 16 may include a braided textile, nylon, PP or polyester material 40 for additional cut resistance and may further include a plurality of metal strands 42 (FIG. 4C). Additionally and/or alternatively, strap member 14 and/or loop member 16 may include a metal cable 44 having multiple twisted metal cords 46.

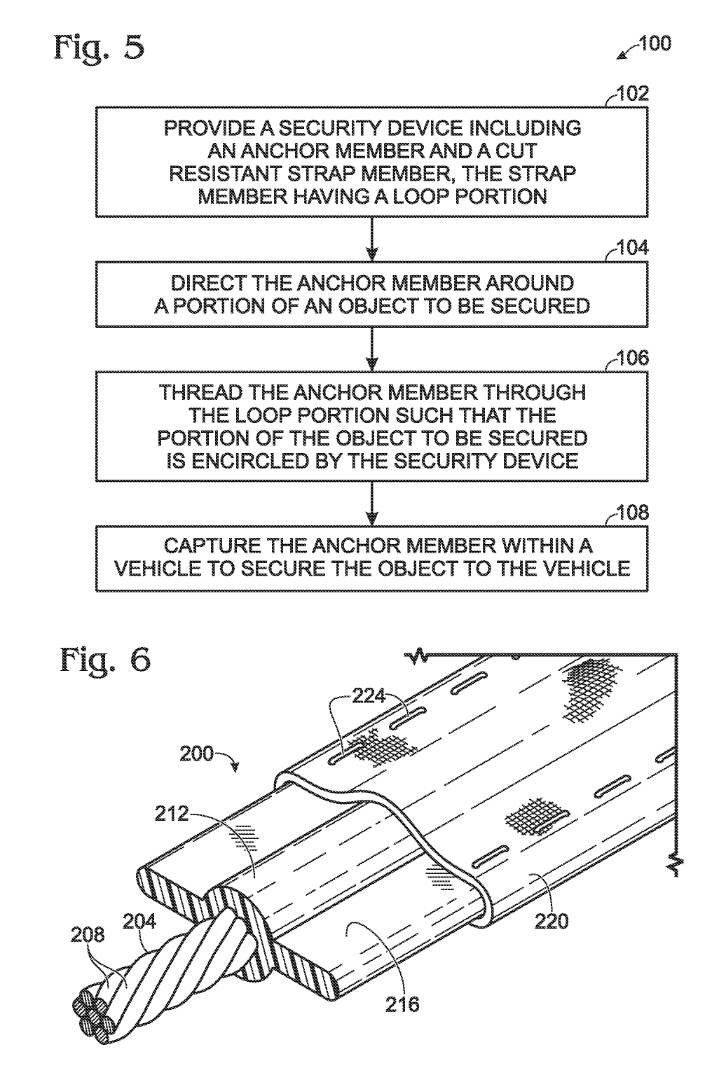

Operation of the security device is described with reference to FIG. 5. A method of securing an object to a vehicle 100 may include providing a security device including strap member having a loop portion and an anchor member 102, and directing anchor member 12 around a portion of the object, for example the bicycle frame (FIG. 3) or other aperture the object to be secured 104. The user may then thread anchor member 12 through the loop portion such that the portion of the object to be secured is encircled by the security device 106. The user may then insert and/or capture anchor member 12 in vehicle 108, for example, by closing a barrier (car door or trunk) to the vehicle. A portion of strap member 14 is sandwiched between the vehicle door and a vehicle frame component. Anchor member 12 may not be pulled through the gap between the barrier and the vehicle frame component. The portion of strap member 14 captured between the vehicle door and a vehicle frame is substantially flat.

Strap 200 includes steel cable 204. Cable 204 may include multiple steel fibers 208 woven or wound together in a rope configuration. Sleeve 212, for example, made of nylon, may be extruded over cable 204. Sleeve 212 has wings 216. Sleeve 212 is contained in webbing 220 which may be made from woven nylon or polypropylene. Stitching 224 is then used to attach webbing 220 to wings 216 of sleeve 212. Use of an extruded sleeve and stitching to connect one or more steel cables to a piece of webbing, prevents sliding of the rope or cable inside the webbing, which otherwise may be exploited to defeat the security device.

The various structural members disclosed herein may be constructed from any suitable material, or combination of materials, such as metal, plastic, nylon, plastic, rubber, or any other materials with sufficient structural strength to withstand the loads incurred during use. Materials may be selected based on their durability, flexibility, weight, and/or aesthetic qualities. It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

Inventions embodied in various combinations and subcombinations of features, functions, elements, and/or properties may be claimed through presentation of new claims in a related application. Such new claims, whether they are directed to a different invention or directed to the same invention, whether different, broader, narrower or equal in scope to the original claims, are also regarded as included within the subject matter of the inventions of the present disclosure.

I claim:

1. A security device for securing an object to a vehicle comprising:
a loop member having a fixed interior circumference;
an anchor member having a circumference that is less than the fixed interior circumference of the loop member; and
a strap member extending at least between the loop member and the anchor member, the strap member including cut-resistant material and a pass-through portion that is thin enough to pass through a gap between a vehicle frame portion and adjacent edge of a closed door;
wherein the length of the strap member between the loop member and the anchor member is at least long enough to allow threading of the anchor member through the loop member.

2. The security device of claim 1, wherein the strap member includes a substantially flat portion adjacent the anchor member.

3. The security device of claim 1, wherein the strap member is configured to be retained between a closed vehicle barrier and a vehicle frame such that the anchor member is secured within the vehicle.

4. The security device of claim 2, wherein the substantially flat portion includes a maximum thickness.

5. The security device of claim 1, wherein the strap member extends from a center portion of the anchor member.

6. The security device of claim 1, wherein the anchor member is joined to a first end of the strap member and the loop member is joined to a second end of the strap member.

7. The security device of claim 2, wherein the width of the substantially flat portion includes a uniform cross section.

8. The security device of claim 1, wherein the anchor member includes a length that is greater than the fixed interior circumference.

9. A security device for securing an object to a vehicle having a vehicle barrier and a vehicle frame comprising:
a strap member having a substantially flat portion configured to be retained between the vehicle barrier and the vehicle frame when the vehicle barrier is in a closed position, the strap member including a cut resistant material;
an anchor member joined to the strap member adjacent the substantially flat portion; and
a loop member joined to the strap member distal the anchor member, the loop member having a fixed interior circumference;
wherein the anchor member is configured to be threadable through the interior circumference of the loop member and be retained within the vehicle.

10. The security device of claim 9, wherein the loop member includes a cut resistant material.

11. The security device of claim 10, wherein the strap member is joined to the anchor member at substantially a center of the anchor member.

12. The security device of claim 9, wherein the anchor member is joined to a first end of the strap member and the loop member is joined to a second end of the strap member.

13. The security device of claim 9, wherein the substantially flat portion includes a maximum thickness.

14. A method of securing an object to a vehicle having a barrier and a barrier frame, comprising:
providing a security device including an anchor member and a cut resistant strap member, the strap member having a loop portion;
directing the anchor member around a portion of the object;
threading the anchor member through the loop portion such that the portion of the object is encircled by the security device; and
capturing the anchor member within the vehicle to secure the object to the vehicle.

15. The method of claim 14, wherein capturing the anchor member within the vehicle further includes closing the vehicle barrier such that a portion of the strap member adjacent the anchor member is between the vehicle barrier and the barrier frame.

16. The method of claim 15, wherein the portion of the strap member captured between the vehicle barrier and the barrier frame includes a maximum thickness.

17. The method of claim 14, wherein the object includes a frame and wherein directing the anchor member includes passing the anchor member through the object frame.

18. The method of claim 14, wherein the object is a bicycle.

19. The method of claim 14, further comprising locking the vehicle with the anchor member inside the vehicle and the loop member outside the vehicle.

20. The method of claim 14, wherein the vehicle includes a roof and the object is on the roof of the vehicle.

21. The method of claim 14, wherein the vehicle barrier and barrier frame is an automobile trunk and a trunk frame.

22. The method of claim 14, wherein the vehicle barrier and barrier frame is a door and a door frame.
